(19) United States
(12) Patent Application Publication
(10) Pub. No.: US 2010/0304953 A1
(43) Pub. Date: Dec. 2, 2010

(54) Zeolite Membranes for Separation of Mixtures Containing Water, Alcohols, or Organics

(75) Inventors: Wei Liu, Richland, WA (US); Jian Zhang, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: BATTELLE MEMORIAL INSTITUTE, Richland, WA (US)

(21) Appl. No.: 12/817,694

(22) Filed: Jun. 17, 2010

Related U.S. Application Data
(63) Continuation-in-part of application No. 12/470,294, filed on May 21, 2009.
(60) Provisional application No. 61/218,521, filed on Jun. 19, 2009.

(51) Int. Cl. B01J 20/28

(52) U.S. Cl. 502/4

(57) ABSTRACT

Zeolite membrane sheets for separation of mixtures containing water, alcohols, or organics are provided, as well as methods for making the same. Thin, but robust, zeolite membrane sheets having a zeolite membrane layer formed directly on a thin porous metal support sheet provide improved separations performance. The zeolite membrane layers have a thickness less than 3 μm and are formed on a thin porous metal support sheet having a thickness less than or equal to approximately 200 μm. The porous metal support sheet comprises an average pore size of less than 3 μm, a porosity between 25% and 75%, and a thickness of less than or equal to 200 μm.

### CROSS-REFERENCE TO RELATED APPLICATIONS

The present application claims priority to, and is a continuation-in-part of, co-pending U.S. patent application Ser. No. 12/470,294, filed May 21, 2009, and claims benefit of U.S. Provisional Patent Application No. 61/218,521, filed Jun. 19, 2009; both are hereby incorporated in their entireties by reference.

### STATEMENT REGARDING FEDERALLY SPONSORED RESEARCH OR DEVELOPMENT

This invention was made with Government support under Contract DE-AC0576RL01830 awarded by the U.S. Department of Energy. The Government has certain rights in the invention.

### BACKGROUND

While membrane separation is viewed as an energy and capital efficient process, present membrane technologies can often fall short of performance requirements for many separation and reaction tasks.

For example, polymeric membranes can be degraded by hydrocarbons that exist in many industrial processes. The polymeric membranes operate at relative low temperatures. The permeation flux and selectivity of the polymeric membrane is relatively low. Inorganic and ceramic membranes, including zeolites, supported on porous substrates can provide high permeation flux and separation selectivity while exhibiting chemical and thermal stability. However, they are typically fragile and are generally made as membrane tubes with a surface area packing density much smaller than the polymeric membranes.

Inorganic membranes can have distinct advantages regarding resistance to degradation by various chemicals, stability at elevated temperatures, and high permeation flux and selectivity. Inorganic membranes are typically tubular in shape or are thick coatings on thick substrates. Tubes are commonly associated with relatively lower surface area packing density and higher cost per unit membrane area and engineering cost. Thick membranes have traditionally been important to seal defects such as pinholes and void structures present in thin membrane films, which are typically caused by less-than-ideal preparation procedures for the substrate structure and membrane. The thicker membranes generally provide low permeation flux and are associated with adhesion problems when the membrane and substrate are two different kinds of materials. For example, thermal mis-match between the membrane coating and substrate material can become pronounced with increasing the membrane thickness. A thick substrate (1 mm or above) is typically used in the conventional zeolite membrane synthesis due to the strength requirement. Porous ceramic tubes or disks are fragile and can easily be broken if made thin. Conventional metal screens or foams have large pores and are weak if made thin. Furthermore, thick substrates can increase the cost and weight of the membrane structure. Thicker substrates also impose additional resistance for the permeate to move through. These issues, and others, have been a major barrier hindering the development of efficient, thin, inorganic membranes having widespread applicability. The present invention addresses these problems and others.

### SUMMARY

The present invention teaches thin but robust zeolite membrane sheets comprising a zeolite membrane formed directly on a thin metal support sheet. The membrane sheets exhibit combined performance attributes, which include high flux and selectivity, chemical and thermal stability, mechanical flexibility and strength, and high surface area packing density, that are not be provided by conventional polymeric, ceramic or metallic membrane products.

Embodiments of the present invention include thin zeolite membrane sheets and methods of making the same. The zeolite membrane sheets comprise a zeolite membrane layer having a thickness less than 3 μm formed on a thin porous metal support sheet having a thickness less than or equal to approximately 200 μm. The zeolite membrane layer is formed by applying a uniform seeding layer to a bare metal surface of the porous metal support sheet. The seeding layer comprises zeolite crystals having an average diameter less than or equal to 1 μm. The porous metal support sheet comprises an average pore size of less than 3 μm, a porosity between 25% and 75%, and a thickness of less than or equal to 200 μm. The support sheet with the seeding layer is immersed in a zeolite growth solution to hydrothermally form an inter-crystal growth layer and complete the zeolite membrane layer. The inter-crystal growth layer incorporates the seeding layer, comprises the same zeolite as the zeolite crystals, and completes uniform formation of the zeolite membrane layer to a thickness less than or equal to approximately 3 μm. Since the porous metal substrate and zeolite membrane layer are two different materials and have different chemical compositions and coefficients of thermal expansion, the thinness of the zeolite membrane layer is critical to achieve good adhesion and to withstand stresses induced during membrane processing and membrane separation operation.

In preferred embodiments, the zeolite material comprises a water selective zeolite, a hydrocarbon-selective zeolite, or an alcohol-selective zeolite. Exemplary water-selective zeolites include, but are not limited to 3A, 4A, and 5A-type zeolite frameworks. Exemplary hydrocarbon-selective and alcohol-selective zeolites include, but are not limited to pure silicalite, titanium silicate, ZSM-5-type and Y-type zeolite frameworks.

The metal support sheet preferably comprises porous Ni, a porous Ni alloy, porous Ti or a porous stainless steel. However, any porous metal support sheet that has an average pore size less than 3 μm, a porosity between 25% and 75%, and a thickness less than or equal to 200 μm can be suitable when the zeolite is formed directly on the bare surface of the support sheet without an intervening transition layer such as a ceramic material having a different composition than the zeolite membrane.

In some embodiments, the seeding layer can be formed by performing multiple applications of the zeolite crystals in a graded pore-size structure. Accordingly, initial zeolite crystals, closest to the porous metal support sheet, would be relatively larger, having average diameters between 0.5 and 3 μm. Penetration of the seed crystals into the metal substrate pores is preferred in order to obtain mechanic inter-locking between the zeolite membrane and the substrate sheet. Subsequent zeolite crystals, closer to the exposed surface of the zeolite membrane layer, would be relatively smaller having average diameters between 50 and 500 nm.

In some embodiments, a plurality of the zeolite membrane sheets can be assembled into a mini-channel module comprising one or more permeate flow channels and one or more membrane channels. The membrane channels are formed by stacking two membrane sheets with the front sides facing one another separated by spacers. The dimensions of the spacers can determine the dimensions of the membrane channels. As used herein, the front side of a membrane sheet refers to the side on which the zeolite membrane is exposed. The back side of the membrane sheet refers to the side on which the bare metal support is exposed. The permeate flow channels are formed by stacking two membrane sheets back side to back side. The back sides of two membrane sheets can directly contact one another or they can be separated by spacers, thereby affecting the dimensions of the permeate flow channel. Feed mixtures flow through the membrane channels. Depending on the particular zeolite material in the zeolite membrane layer, certain components in the feed mixture will selectively pass through the membrane and enter the permeate flow channels, driven by a chemical potential gradient of the components across the membrane. The chemical potential gradient may be generated by partial pressure difference and/or concentration difference. The stacked pair of membrane channels and permeate flow channels can be alternately repeated to form a scalable assembly comprising a plurality of membrane and permeate flow channels. The surface area packing density of the modules assembled according to embodiments of the present invention meet or exceed 1000 m²/m³. In preferred embodiments, the permeate flow channels and the membrane channels are oriented in a cross-flow configuration.

In some embodiments, a separation module can be simply assembled by packing two membrane sheets back-to back into a plate-like module with an optional internal opening. The front-end of the membrane is exposed to the feed fluid mixture, while the permeate is removed through the opening inside the plate. The plate thickness, which is composed of the membrane sheets and any opening between them, is a critical design parameter, since it determines the membrane surface area packing density and flow resistance for the permeate to move out of the membrane plate. Plate thicknesses less than 6 mm is preferred to obtain a surface area packing density higher than conventional membrane tubes.

According to another embodiment, two zeolite membrane sheets can be assembled into a membrane plate module comprising only a permeate flow channel. The two membrane sheets are stacked such that the zeolite membrane layer on the front sides are exposed to feed mixtures on the exterior of the membrane plate module. The permeate flow channel is formed between the zeolite membranes sheets, which are stacked back side to back side. Certain components in the feed mixture will selectively pass through the membrane layers from the exterior of the membrane plate module into the permeate flow channel.

The present invention can be used in association with membrane separation and membrane reactors resulting in higher energy efficiency and/or lower capital costs. There are a range of energy conversion and environmental applications, such as, process water removal, ethanol or high alcohol production from biomass, CO₂ capture from a gas mixture, and removal of particular hydrocarbons from solvents or hydrocarbon mixtures.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### BRIEF DESCRIPTION OF THE DRAWINGS

FIG. 1a-1c are scanning electron microscope micrographs of an embodiment of a zeolite membrane sheet in which the membrane layer was prepared with a seeding layer and using a template-free synthesis solution.

FIGS. 2a-1d are scanning electron microscope micrographs of an embodiment of a hydrocarbon-selective and/or alcohol-selective zeolite membrane sheet in which the membrane layer was prepared with a seeding layer and using a template-containing synthesis solution.

FIG. 2e is a X-ray diffraction spectrum obtained from an embodiment of a hydrocarbon-selective and/or alcohol-selective zeolite membrane sheet in which the membrane layer was prepared with a seeding layer and using a template-containing synthesis solution.

FIGS. 3a-3d are scanning electron microscope micrographs of an embodiment of a water-selective zeolite membrane sheet in which the zeolite membrane is formed directly on the support sheet without a seeding layer.

FIG. 3e is a X-ray diffraction spectrum obtained from an embodiment of a water-selective zeolite membrane sheet in which the zeolite membrane is formed directly on the support sheet without a seeding layer.

FIG. 4 is a plot of water permeation flux and water/ethanol selectivity factor as a function of temperature using an embodiment of a water-selective membrane sheet.

FIG. 5 is a plot of water flux and water/ethanol selectivity as a function of weight percent water in the feed mixture using an embodiment of a water-selective membrane sheet.

FIG. 6 is a plot of water flux and water/ethanol selectivity as a function of time on stream using an embodiment of a water-selective membrane sheet.

FIGS. 7a and 7b are illustrations depicting an embodiment of a mini-channel membrane module according to the present invention.

FIG. 8 is an illustration depicting an embodiment of a plate-type membrane module according to the present invention

### DETAILED DESCRIPTION

The following description includes the preferred best mode as well as other embodiments of the present invention. It will be clear from the description of the invention that the invention is not limited to the illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed. On the contrary, the invention is to cover all modifications, alternative constructions, and equivalents falling within the spirit and scope of the invention as defined in the claims.

Rather than using nano-metal particles to form the thin, porous metal support sheets, embodiments of the present invention start with metal precursor materials such as oxides, hydrides, and metal-organics that can be acquired from commercial sources at bulk quantities. The metal precursors are mixed with pore formers and other additives to form a homogenous slurry batch at micro- and nano-scale mixing. The slurry is cast into plates or sheets. The green sheet is dried at low temperatures to generate micro-pores inside the body, which allows gas permeate inside in the subsequent step. Then, the metal precursor(s) is converted into metallic state or alloy by an appropriate high-temperature reaction processes, such as, oxidation followed by H₂ reduction, direct reduction by the pore former and H₂ gas, reduction and carbonization with carbon monoxide, etc. The metal crystal size and sintering can be controlled by the reaction conditions. This process step results in a metallic backbone of uniform pore sizes at micrometer or sub-micro-meter level. Furthermore, modifiers can be introduced into the metal phase through the porous matrix by chemical or physical process methods. The modified porous metal sheet can be annealed under suitable gas environment and conditions to produce targeted crystal phase and compositions. Preferably, the porous metal sheet can be annealed by applying a load onto the sheet during annealing to keep the sheet flat and minimize warping. The support sheet synthesis technique described above allows decoupling of material forming process at atomic, nano-, micro-, and macro-scales. Different from traditional metal foaming processes, embodiments of the present invention use non-pure metal precursor materials, produce much smaller pores, and utilize the porous network for tailoring of the metal grain and bonding. Once the support sheet is formed, it is available for formation of a zeolite membrane layer on one side of the sheet (i.e., the front side).

In one example, a zeolite membrane layer is formed directly on the porous metal support sheet having a seeding layer. The seeding layer can be formed using a seeding solution comprising zeolite seed crystals mixed with de-ionized water. While various zeolite materials can be suitable depending on the processing conditions and desired separations, preferably, the zeolite material for the seed crystals and the membrane layer are 4A (or NaA-type), ZSM-5, or silicalite. An exemplary zeolite loading is 3 wt %, although other loadings can be suitable and appropriate. The seeding solution can be sonicated or ball milled to break up larger particle agglomerates, resulting in a stable and uniform suspension.

In some instances, multiple seeding solutions can be prepared each comprising a different size of crystals. For example, a first solution can comprise 1 μm crystals and a second solution can comprise 100 nm crystals. Preferably, the crystals in the solution are pure and uniform with regard to size distribution. Deposition of strange particulates or particulate in the seed coating layer would likely cause membrane defects.

The seeding solution can be applied onto one side (i.e., the front side) of the porous metal support sheet by dip coating, slip coating or flow coating techniques. A protective layer can be applied to the opposite side of the support (i.e., the back side) to limit formation of the seeding layer to the front side. An exemplary protective layer can include a fluoropolymer material, such as polytetrafluoroethylene (PTFE), that is stable in the coating and growth solution. Generally, any material that can mask the back side to prevent zeolite formation can be suitable.

The front side of the porous metal support sheet contacts the seeding solution for a certain time typically ranging from a few seconds to one minute. The support sheet should contact with the solution in uniform manner to obtain a uniform coating. The other side of the support sheet is protected by a cover to prevent its contact from the solution. The zeolite seeding crystals are deposited on the support sheet surface by capillary force upon contacting. If the contact time is too short, the coating layer may not be fully developed. If the contact time is too long, the coating layer may be re-dissolved back into the solution. The optimum contact time is dependent on the support sheet properties and solution properties. After the support sheet/solution contact, the excessive solution is removed from the sheet surface by drainage due to gravity or by centrigual force. The wetted sample is placed an oven to dry at 60 to 120° C.

Typically, the substrate is coated two times. The first layer of coating is made by using a solution having larger crystal sizes, while the second layer of coating is made by using a solution having smaller size crystals. The sample is dried between the coatings. Additional coatings can be applied, but are not preferable. The multiple coatings can result in a graded pore structure, in which pore size increases from the surface region toward the metal substrate. In preferred embodiments, the seeding layer thickness is not more than three times the size of the pore opening in the metal support sheet. For example, for pore sizes of 1 μm, the seeding layer thickness should be less than 3 μm. Thicker coatings tend to result in delamination and/or mismatch between the zeolite layer and the metal support sheet.

After the seeding layer is dried, it is typically loose and does not yet comprise an acceptable zeolite membrane because of the voids between zeolite crystals. Accordingly, the zeolite membrane layer is completed by forming the inter-crystal growth layer. Inter-crystal growth is conducted inside a hydrothermal reactor. The seeded metal substrate sheet is placed inside a pressure vessel and completely immersed inside the growth solution. The growth is conducted at temperatures from 80 to 200° C. for 1 to 12 hours. The reactor can be pressurized to a value that keeps the water in liquid phase.

During the inter-crystal layer growth, zeolite crystal growth fills up the voids between the seeding crystals and bonds the seeding crystals together, which results in a continuous, strong layer. The dense, continuous zeolite membrane layer is surprisingly free of pinholes and gaps. The zeolite membrane layer leaves zeolite lattice channels as the only paths across which molecules can diffuse, thereby providing molecular sieving functionality. The hydrothermal growth may be repeated if some pin-holes remain.

The particular growth time and temperature can depend on the growth solution compositions and the kind of zeolite membrane being prepared. Generally, the zeolite crystal growth rate increases with temperature, and crystal size grows with time in solution. Shorter growth times tend to leave some voids and/or defects in the membrane. If the growth rate is too slow, some side reactions can occur. The zeolite growth is preferred to occur in the zeolite seeding layer and not anywhere else. Thus, the growth conditions are controlled in a way that a thin, dense zeolite membrane film is formed.

After the hydrothermal growth, the residual solution and any particulates on the sheet are rinsed away with de-ionized water and the membrane sheet is then subjected to an appropriate post-treatment. For example, if an organic template had been used in the growth solution, a heat treatment in oxygen and/or nitrogen could be necessary to burn out the organic template.

In a specific example, the template-free solution for the water-selective zeolite membrane, NaA, has a composition comprising 4Na:2Si:2Al:150H₂O. It is prepared by forming an aluminate solution by dissolving 7.95 g sodium hydroxide (Wako, >97%) and 10.82 g aluminum hydroxide (Wako, >95%) in 45 g D.I. water by stirring at 100° C. (temperature measured by thermometer) for 30 minutes to get a non-clear solution. A silicate solution was prepared by dissolving 13.78 g sodium silicate (Wako, 17-23% Na₂O) in 123 g D.E. water by stirring at 50° C. for 2 hours to get a clear solution. The aluminate solution was then added into the silicalite solution drop-wise at room temperature and the resulting mixture was stirred vigorously for 30 minutes at room temperature to produce a homogeneous gel without observable precipitation or phase segregation. The preferred conditions for inter-crystal layer growth using the above solution are about 3 hours and 100° C.

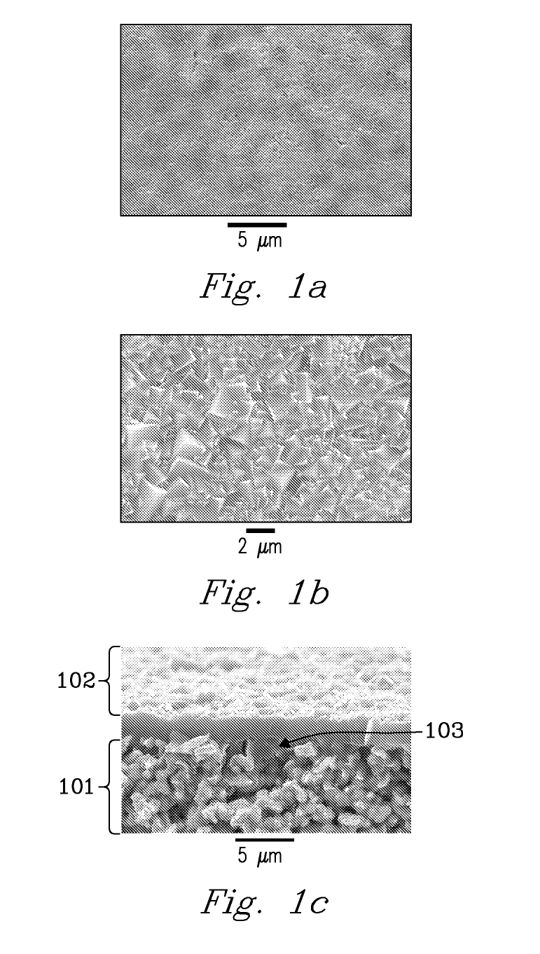

FIGS. 1a-1c are scanning electron microscope (SEM) micrographs showing the structure of the water-selective (NaA) membrane prepared by hydrothermal growth of seeded porous metal substrate with template-free synthesis solution, as described above. FIG. 1a shows the surface of the porous metal substrate coated with seed crystals having a size of about 0.3 μm. FIG. 1b shows the surface of the membrane layer after hydrothermal growth. FIG. 1c is a cross-sectional view of the membrane sheet. The pores of the large metal support 101 are fully covered by two times of coating with NaA seed crystals of about 0.3 μm crystal sizes. Distinctive seed crystals are visible on the seeded substrate. A dense and continuous zeolite membrane 102 is formed after hydrothermal growth. The cross-sectional view of fractured membrane sheet shows certain penetration 103 of the seed crystal into the support pore, which is important to have strong adhesion.

For forming a hydrocarbon-selective or an alcohol-selective membrane, a similar procedure is followed except the seeding and inter-crystal growth solutions would contain precursors for the hydrocarbon-selective or the alcohol-selective zeolite and, in the particular example below, a template-containing synthesis solution was used. For example, a silicalite membrane can be prepared according to the following. A thin porous Ni sheet is first spin-coated with approximately 100 nm silicalite seed crystals. The seeding suspension was prepared by mixing 10 g of 3 wt % silicalite suspension with 4 g of 20 wt % polyethylene glycol (PEG) solution and 5 g of 25 wt % surfactant C₁₈EO₁₀/isopropanol solution under sonication. The suspension was shaken for two days. The seeding suspension was degassed and filtered using a 5 μm filter before spin coating. The thin porous Ni sheet was placed on a magnet tape and the spin-coating was conducted using a spin coater. The spin rate was 1500 rpm. After that, the seed-coated substrate was dried at 150° C. for 20 minutes.

The silicalite synthesis solution for hydrothermal growth had a molar composition of 1.0 TPAOH:8.14 TEOS:589H₂O and was prepared by mixing 5.65 ml Tetrapropylammonium hydroxide (TPAOH, 1M solution in water, Aldrich), 10.2 ml Tetraethyl Orthosilicate (TEOS, 98%, Acros) and 60 ml D.I. water. The mixture was stirred at 50° C. for 2 hours and a clear solution was obtained. A disc substrate was mounted in a reactor with its seeded surface facing down-wards. The reactor was put into an oven pre-heated to 180° C. for 2 hours and then cooled down naturally in air. The sample was taken out, rinsed under running D.I. water, dried with compressed air, and kept in a 50° C. oven overnight. The silicalite membrane sheet was then heated at 400° C. for 4 hours in 2 vol. % O₂/N₂ mixture. The rate for both heating and cooling were 1° C./min.

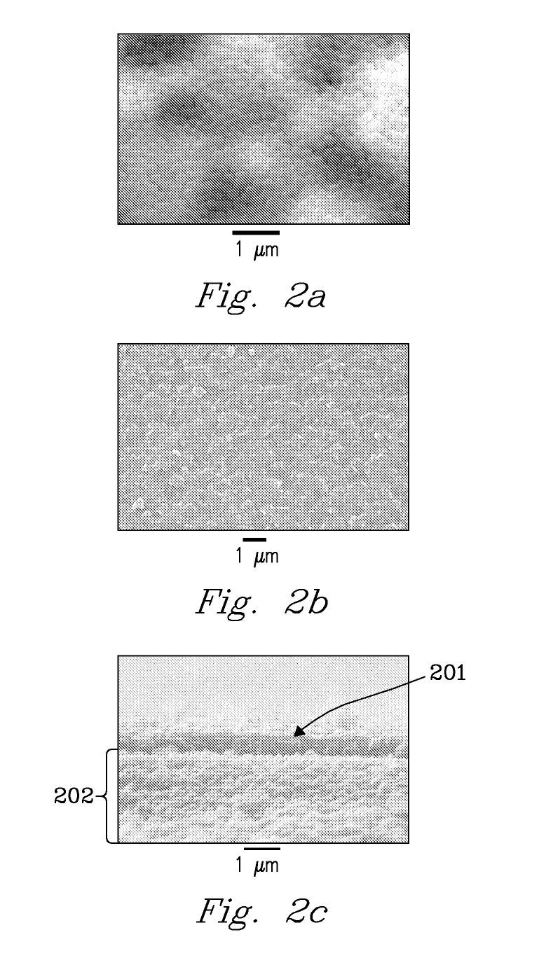

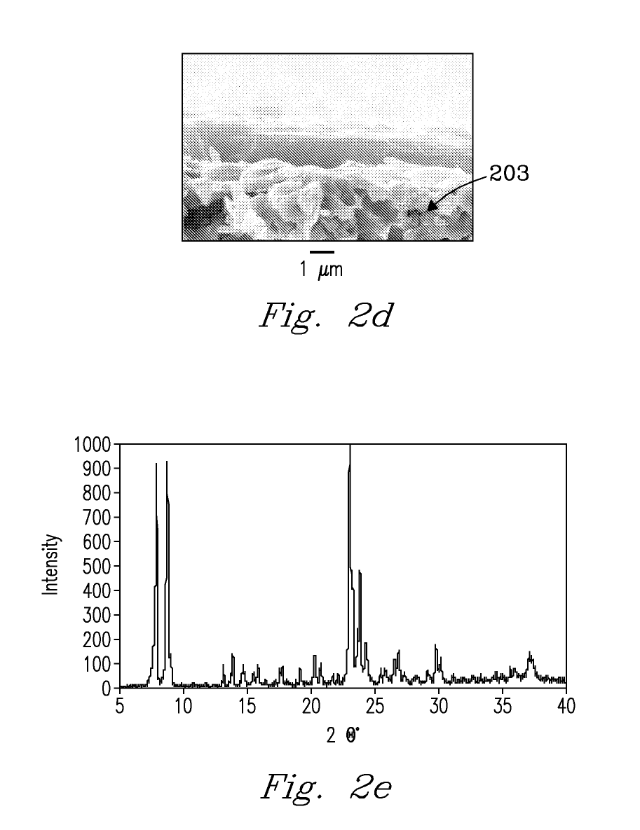

FIG. 2a-2d are SEM micrographs obtained from a hydrocarbon-selective and/or alcohol-selective zeolite membrane formed according to embodiments of the present invention. FIG. 2a shows the porous metal substrate coated with silicalite seed crystals. FIG. 2b shows the surface of the membrane layer after hydrothermal growth and calcination. FIG. 2c is a cross-sectional view of the membrane sheet. FIG. 2d is another cross-sectional view showing a smaller scale with greater detail and, again, shows certain penetration 203 of the seed crystal into the support pore. The membrane was prepared by hydrothermal growth of the seeded substrate with a template-containing synthesis solution as described above. Referring to FIG. 2c, a continuous zeolite film 201 of thickness 1˜2 um is formed on the substrate 202. Referring to the X-ray Diffraction (XRD) spectrum in FIG. 2e, existence of the zeolite crystal structure is verified by the thin-film XRD measurement.

In some instances, the zeolite membrane layer can be formed directly on the porous metallic sheet without the use of a seeding layer: For example, a NaA zeolite membrane can be formed on a thin, porous metal support sheet without a seeding layer using a synthesis solution having a molar composition of 10Na₂O:0.2Al₂O₃:SiO₂:200H₂O. The solution was prepared by combining 0.2 g aluminum powder (200 mesh, 99.95+%, Aldrich) and 64.12 g DI water in a 250 ml polypropylene bottle and stirring for about 10 mins. 14.828 g of sodium hydroxide (Aldrich) was added and the bottle quickly capped. Stirring for additional 30 minutes. 3.71 g Ludox LS30 colloidal silica (30 wt %, silica, Aldrich) was added drop-wise to the stirring solution. Solution was stirred for approximately 4 hrs until it become clear.

The direct hydrothermal growth was performed in a reactor with the front side of the porous Ni support sheet facing downward. The back side of the support sheet was covered with Teflon or the another substrate to avoid crystal growth. 18 ml of the NaA synthesis solution was poured into the reactor. The reactor was then sealed and heated in a pre-heated oven at 65° C. for 7 hours. After the hydrothermal growth, the reactor was cooled down naturally in air. The NaA membrane sheet was taken out, rinsed under running D.I. water, dried with compressed air, and kept at 50° C. overnight. The membrane was then heated at 400° C. for 4 hours in 2 vol. % O₂/N₂ mixture. The rate for both heating and cooling were 1° C./min.

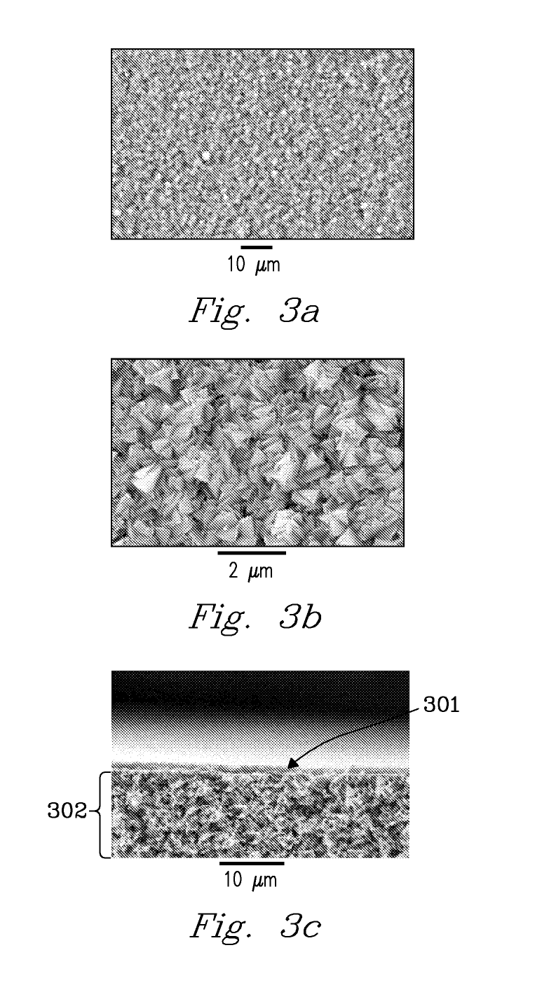

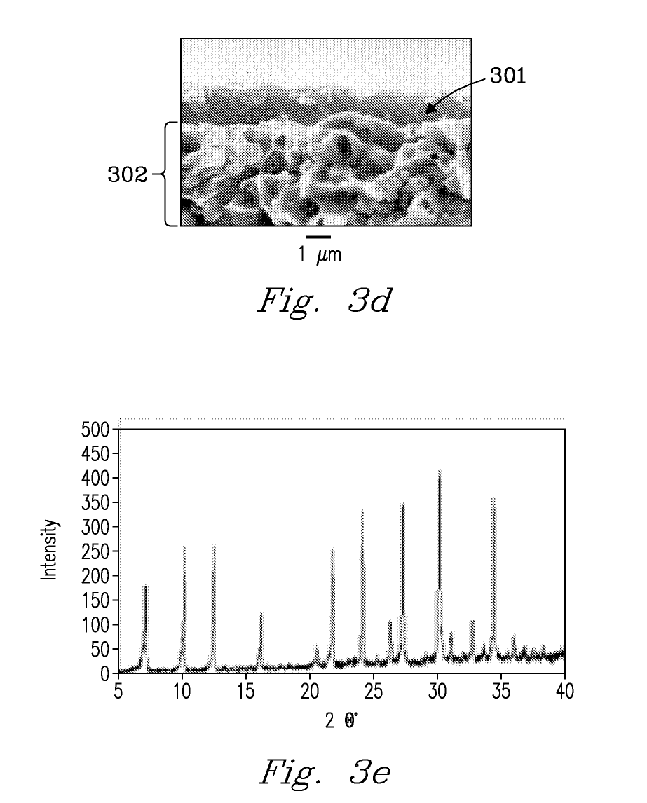

FIGS. 3a-3d show SEM micrographs obtained from a hydrophilic-type zeolite NaA membrane. FIGS. 3a and 3b show at two different scales the surface of the membrane layer after hydrothermal growth. FIGS. 3c and 3d are a cross-sectional views at two different scales of the membrane sheet. A continuous zeolite film 301 having a thickness less than 2 μm is formed directly on the substrate 302 without a seeding layer. The structure of the membrane layer can be seen in the micrographs. Referring to the XRD spectrum in FIG. 3e, existence of the zeolite crystal structure and composition is determined by the thin-film XRD measurement. This membrane was prepared by the direct growth technique as described above.

TABLE 1
Testing results of a water-selective
membrane for water removal from air.

| Feed Side Pressure | Permeance (mol/m²/s/Pa) | | H₂O/O₂ Separation |
|---|---|---|---|
| (bar) | H₂O | O₂ | Factor |
| 1 | 6.7E−08 | 6.0E−10 | 108 |
| 2 | 2.9E−08 | 6.8E−10 | 43 |
| 3 | 1.5E−08 | 3.6E−10 | 43 |

Testing conditions:
Feed side: 20 sccm of moisturized air (38.7% relative humidity, H2O molar fraction 0.0051),
Permeation side: atmospheric pressure, 40 sccm of He gas purge 24.5° C.
Separation temperature: 24.5° C.

Tables 1 and 2 show testing results for the water selective membrane of FIG. 3 with respect to water removal from air and from a water/ethanol mixture, respectively. Table 1 demonstrates that the NaA membrane is selective toward water vapor. The H2O permeance is about two orders of magnitude higher than the O₂ permeance. However, the water vapor permeance decreases with increasing feed side pressure (or pressure gradient). This suggests that the membrane in the feed side is saturated and water vapor permeation rate is limited by diffusion rate of the adsorbed H₂O rather than by gas-phase diffusion of H₂O.

TABLE 2
Testing results of the water-selective membrane for
removal of water from water/ethanol liquid feed.

| | | | Permeation | Water in | H₂O/EtOH |
|---|---|---|---|---|---|
| Separation | Separation | Sampling | Flux | Permeate | separation |
| Temp, ° C. | Process | Time, h | (kg/m2/h) | (wt %) | factor |
| 60 | Pervaporation | 24 | 0.046 | 89.6 | 78 |
| 90 | Gas-phase | 16 | 0.32 | 94.2 | 146 |
| 105 | Gas-Phase | 5.5 | 0.37 | 97.5 | 351 |

Testing conditions:
Feed side: Continuous flow of 10 wt % water/ethanol liquid mixture, atmospheric pressure
Permeate side: Vacuum (−12.86 psi)

The separation performance of the water-selective membrane was further tested by feeding a water/ethanol liquid mixture into the membrane test cell. The feed mixture passes over the front side of the membrane. The permeate was pulled out by vacuum from the back side of the membrane and collected in the liquid N₂ trap. The testing conditions and results are listed in Table 2. At a separation temperature of 60° C., the separation process can be viewed as pervaporation, that is, liquid phase in the feed side and vapor-phase in the permeate side. At 90 and 105° C., the liquid feed should be vaporized and thus, the separation occurs in the gas-phase. The permeation flux significantly increases as the temperature is raised from 60 to 90 and 105° C., while the H₂O/EtOH separation factor increases at the same time. The results suggest that the present membrane performs well for gas-phase separation. The water content is concentrated to above 90% in the permeate side from 10 wt. % in the feed side

TABLE 3
Testing results of the hydrophobic membrane for
selective removal of ethanol from ethanol/water
liquid by pulling vacuum in permeate side

| | | EtOH | EtOH | EtOH/H₂O |
|---|---|---|---|---|
| Separation | Testing | wt % in | flux, | separation |
| Temp, ° C. | time, h | permeate | kg/m²/h | factor |
| 60 | 14.5 | 28.6% | 0.152 | 3.6 |
| 75 | 3.5 | 35.6% | 0.256 | 5.0 |
| 90 | 3.5 | 59.9% | 0.625 | 13.5 |

Testing conditions:
Feed: 10 wt. % EtOH/water liquid flow, atmospheric pressure
Permeate: vacuum (−12.7 psi)

TABLE 4
Testing results of the hydrophobic membrane for selective removal
of ethanol from ethanol/water liquid by gas sweep in permeate side

| | | EtOH | EtOH | EtOH/H₂O |
|---|---|---|---|---|
| Separation | Testing | wt % in | flux, | separation |
| Temp, ° C. | time, h | permeate | kg/m²/h | factor |
| 60 | 2.5 | 62.3% | 0.23 | 14.9 |
| 75 | 1.75 | 55.7% | 0.44 | 11.3 |
| 90 | 1.0 | 61.1% | 0.84 | 14.1 |

Testing conditions:
Feed: 10 wt. % EtOH/water liquid flow, atmospheric pressure
Permeate: 100 sccm of He sweep gas flow, atmospheric pressure

The hydrocarbon-selective and/or alcohol-selective zeolite membrane shown in FIG. 2 was tested for ethanol/water separation by feeding 10 wt % ethanol/water liquid into the membrane testing cell. Table 3 lists testing results by pulling vacuum in the permeate side, while results in Table 4 were obtained by use of a sweep gas on the permeate side. The hydrocarbon-selective and/or alcohol-selective zeolite membrane is clearly selective toward EtOH permeation over H₂O. Both permeation flux and EtOH/H₂O separation factor increases with separation temperature if the permeated is pulled by vacuum. By use of He sweep gas, the permeation flux still increases with temperature but the separation factor is nearly constant. The permeation flux with He sweep is consistently higher than the vacuum pulling.

The impact of membrane preparation conditions on separation performance of silicalite membrane sheets is illustrated by the experimental results in Table 5. Three membrane sheets were prepared with the same process steps. Briefly, each porous Ni sheet was coated two times with seed crystals of about 100 nm sizes dispersed in de-ionized water. The seed crystals were precalcined at 600° C. for 5 h in air prior to making the coating suspension. The seeded substrate was grown in an autoclave reactor with the same templated solution but under different conditions. Membranes 1, 2 and 3 were synthesized at hydrothermal reaction temperatures of 140° C., 160° C., and 180° C., respectively. After growth, the membrane samples were treated 2 h at 400° C. in 2% O₂/N₂ flow with 1° C./min temperature ramp rate (profile 1). After calcination at 400° C., membrane 3 was further heated in a pure hydrogen gas flow at 600° C. for 2 h with PC/min temperature ramp rate, that is, profile 2. The resulting membranes were tested On the same testing apparatus under the same conditions. 10 wt % EtOH in H₂O liquid was fed into the membrane testing cell at flow rate of 1 cc/min under atmospheric pressure, while the permeate was removed by vacuum at 1 torr. It can be seen that membrane 1, which was synthesized by 2 hours of growth at 140° C., gave the highest permeation flux and good selectivity.

TABLE 5
Impact of silicalite synthesis conditions
on membrane separation performance.

| Membrane # | 1 | 2 | 3 |
|---|---|---|---|
| Growth conditions | 140 C., 2 h | 160 C., 2 h | 180 C., 2 h |
| Post treatment | Profile 1 | Profile 1 | Profile 2 |

Separation performance

| | | | |
|---|---|---|---|
| Temp, ° C. | 75 | 75 | 75 |
| H2O/ethanol selectivity | 22.8 | 30.0 | 2.0 |
| Total flux, kg/m²/h | 1.69 | 0.91 | 0.68 |

The impact of the synthesis conditions on separation performance of the H₂O-selective zeolite membrane is shown by the experimental results in Table 5. The porous Ni substrate sheet was first coated with the NaA zeolite seed of about 1.0 μm crystal sizes and followed with the about 0.3 μm zeolite crystal size. The zeolite membrane growth of the seeded substrate was conducted in an autoclave reactor with a template-free growth solution. With the same seeded substrate and same synthesis solution, separation performance is dramatically affected by the hydrothermal growth temperature. Both H₂O flux and H₂O/ethanol selectivity were substantially increased by raising the growth temperature from 90 to 100° C. However, further increasing the growth temperature to 110° C. caused decline of H₂O/ethanol selectivity. Several reaction processes occur simultaneously during the hydrothermal reaction process. Thus, the reaction conditions need to be well controlled to obtain the optimum zeolite membrane structure.

TABLE 6
Impact of hydrothermal growth conditions
on H2O-selective membrane performance

| Membrane # | NaA 1 | NaA 2 | NaA 3 |
|---|---|---|---|
| Growth conditions | 90° C., | 100° C., | 110° C., |
| | 3.5 hrs | 3.5 h | 3.5 hrs |

Separation performance^{a}

| | | | |
|---|---|---|---|
| Flux, kg/(m² · h) | 0.9 | 3.8 | 3.5 |
| Ethanol in permeate, g/L | 50.16 | 0.33 | 12.84 |
| H₂O/EtOH selectivity factor | 168 | 27,465 | 689 |

^{a}The membrane separation performance was characterized with 90 wt. % ethanol/water feed at 75° C. The feed was under atmospheric pressure, while the permeate side was under vacuum of ~1 torr.

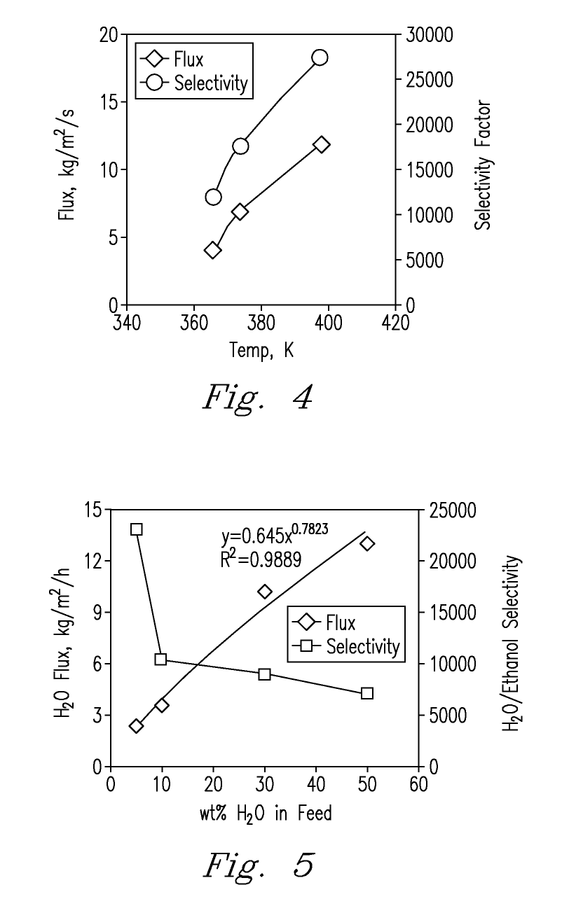

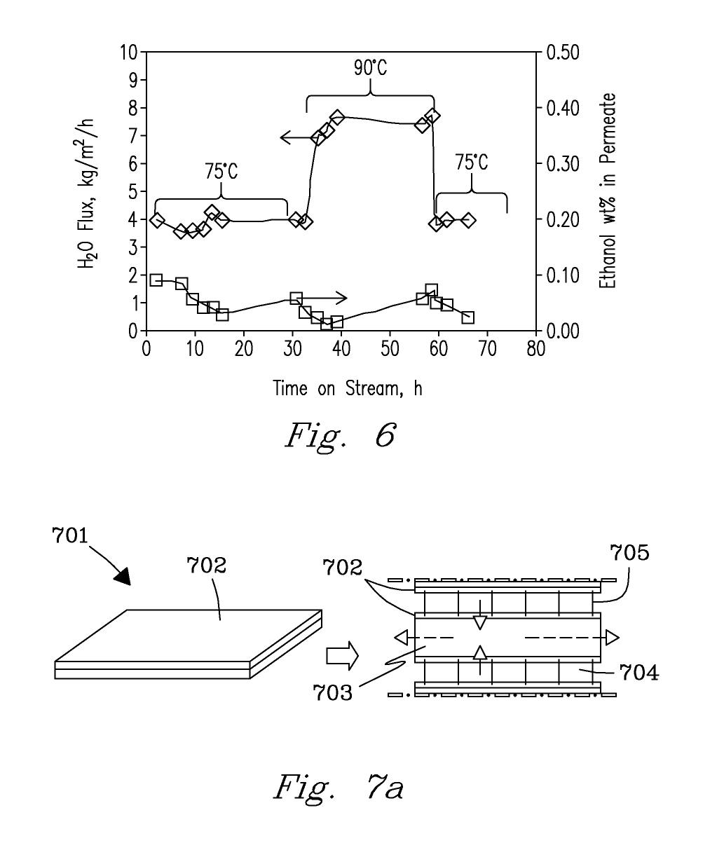

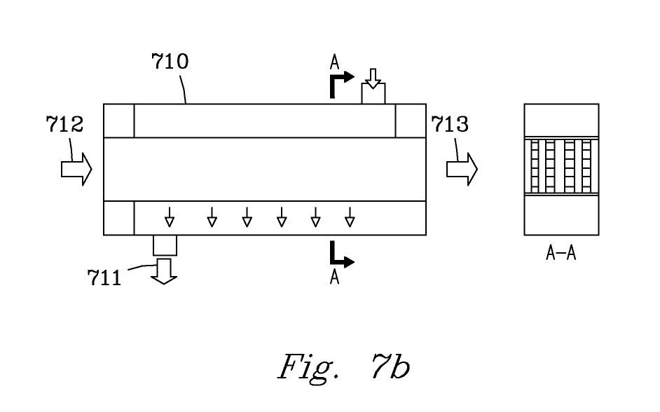

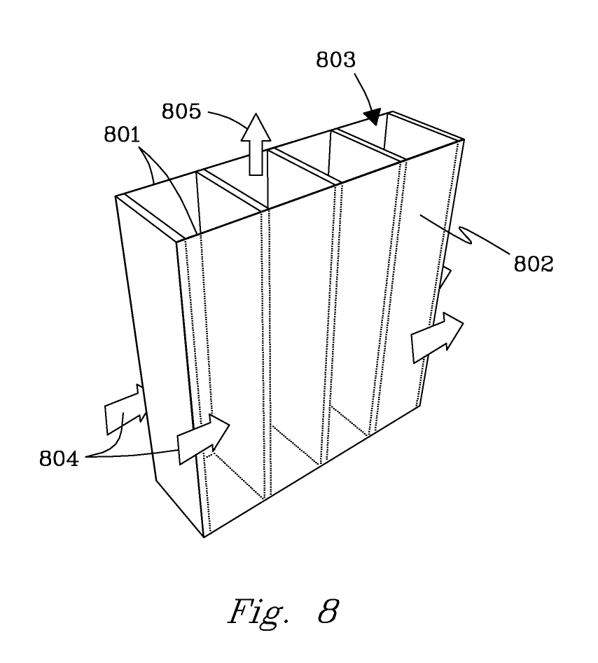

Robustness and high quality of the H₂O-selective membrane prepared under preferred conditions (NaA#2 in Table 6 have been demonstrated by separation testing under various conditions. FIG. 4 shows that both water permeation flux and H₂O/ethanol selectivity increase with separation temperature. In this set of testing, 10 wt % H₂O/ethanol feed was introduced into the membrane cell under atmospheric pressure and the permeate was removed by vacuum of 1 ton. The results clearly illustrate unique performance attribute of the zeolite membrane over a range of separation temperature. The membrane provided fairly high flux and selectivity at the testing temperature of 408K (135° C.). Most traditional polymeric membranes could not function at such high temperatures. The trend of concomitant increase of flux and selectivity is exceptionally desirable for a practical separation application, since most membranes in prior arts were encountered with a trade-off between the flux and selectivity, that is, decline of the selectivity with increasing flux. FIG. 5 shows membrane separation performance with different water content in the feed water/ethanol mixture at separation temperature of 75° C. The H₂O permeation flux increases with the feed wt. %, which can be explained by the increased partial pressure gradient of water vapor across the membrane. The H₂O/ethanol selectivity decreases with increasing wt % H₂O in the feed. This kind of performance attribute is very desirable for deep drying by the membrane separation. However, the lowest selectivity is still around 6000 and is high enough to meet practical separation application. Stability is critical for practical application of any membranes. FIG. 6 shows variations of the flux and the water content of the permeate with time on stream. The H₂O flux was stable around 4.0 kg/m2/h at separation temperature of 75° C., rapidly increased to 7.5 kg/m2/h upon increase of the temperature to 90° C., and went back to the same flux level after the temperature was cooled down to 75° C. The results show rapid response of the membrane to the change of separation temperature and stability of the membrane structure under these separation conditions. Compared to 90 wt % ethanol in the feed, the ethanol content in the permeate was very low, typically below 0.05 wt %, which corresponds to a H₂O/ethanol selectivity factor above 10,000.

TABLE 7
Comparison of H₂O-selective zeolite membranes
(4A or NaA-type) for ethanol/water separation.

| | Water in | | Permeate | | | |
|---|---|---|---|---|---|---|
| | feed | | pressure | Flux | | |
| Support | (wt %) | T(K) | (kPa) | (Kg/m²/h) | Selectivity | Ref. # |
| metal sheet | 10 | 363 | 0.1-0.2 | 7.5 | >10,000 | n/a |
| metal sheet | 10 | 348 | 0.1-0.2 | 4.0 | >10,000 | n/a |
| alumina tube | 10 | 348 | 0.7 | 5.6 | >5,000 | 69 |
| | 10 | 378 | NA | 4.5 | >10,000 | 10 |
| alumina tube | 10 | 398 | 0.05 | 3.8 | 3,600 | 81 |
| alumina tube | 9.2 | 366 | 0.5 | 2.5 | 130 | 65 |
| | 10 | 348 | NA | 2.2 | >10,000 | 10 |
| | 5 | 348 | NA | 1.1 | >10000 | 10 |
| TiO₂ | 10 | 323 | 0.2 | 0.8-1.0 | 8,500 | 13 |
| alumina tube | 10 | 353 | NA | 0.54 | >10000 | 102 |
| alumina tube | 10 | 323 | 0.2 | 0.5 | 16,000 | 70 |
| alumina tube | 5 | 318 | 0.4 | 0.23 | 8,300 | 61 |
| Silica tube | 3 | 333 | NA | 0.37 | 70 | 79 |

Ref. # in Table 5 of S.-L. Wee et al. Separation and Purification Technology 63 (2008) 500-516.

Referring to Table 7, the performance of various water-selective zeolite membranes (4A or NaA-type) in water/ethanol separations are summarized. The first two rows summarize the performance of 4A zeolite membrane layers on porous metal support sheets according to embodiments of the present invention. The performance data on the remaining membrane materials is summarized from that which was reported in Table 5 of S.-L. Wee et al. Separation and Purification Technology 63 (2008) 500-516. For the same-type zeolite material, ethanol/water separation performances of the membrane sheets formed according to embodiments of the present invention are significantly better than that which is reported in the prior art with respect to the combination of required flux and selectivity.

TABLE 8
Comparison of different membranes for ethanol/water Separation

| | | Water in | | Permeate | | | |
|---|---|---|---|---|---|---|---|
| | | feed | | pressure | Flux | | |
| Membrane | Support | (wt %) | T(K) | (kPa) | (Kg/m²/h) | Selectivity | Ref. # |
| NaA | metal sheet | 10 | 348 | 0.1-0.2 | 4.0 | >10,000 | n/a |
| NaA | metal sheet | 10 | 363 | 0.1-0.2 | 7.5 | >10,000 | n/a |
| Mordenite | alumina | 10 | 423 | 0.5 | 0.2 | 139 | a - 35 |
| | tube | | | | | | |
| Mordenite | alumina | 15 | 363 | 0.2 | 0.1 | 60 | a - 68 |
| | tube | | | | | | |
| NaX | | 10 | 348 | NA | 0.9 | 360 | b |
| NaY | | 10 | 348 | NA | 1.6 | 130 | b |
| Silica | alumina | 10 | 353 | 0.6-0.8 | 1.0 | 800 | a - 8 |
| | disc | | | | | | |

Polymeric/Composites listed below

| | | | | | | |
|---|---|---|---|---|---|---|
| Silica/Acrylamide | 10 | 323 | NA | 0.30 | 3200 | b |
| CMC (Na ion) | 10 | 303 | NA | 0.05 | 2430 | b |
| GFT | 5 | 353 | NA | 0.01 | 9500 | b |
| PAA/polyion | 5 | 333 | NA | 1.63 | 3500 | b |
| Chitosan | 10 | 333 | NA | 0.10 | 6000 | b |
| Polyimide | 10 | 348 | NA | 0.01 | 850 | b |

a. Ref. # in Table 5 of S.-L. Wee et al. Sep. Purif. Technol. 263 (2008) 500-516.
b. Y. Morigami et al. Sep. Purif. Technol. 25 (2001) 251-260.

Similarly, referring to Table 8, the membrane sheets of the present invention exhibit better performance than many other membrane materials with respect to the combination of required permeate pressure, flux, and selectivity. The first two rows of Table 8 summarize the performance of 4A zeolite membrane layers on porous metal support sheets according to embodiments of the present invention. No other materials exhibit the same level of high performance.

Zeolite membrane growth on the ceramics-modified porous Ni sheet were also tested to demonstrate the limitations of using a ceramic transition layer. A layer of yittia-stabilized zirconia (YSZ) of mean pore sizes about 200 nm could be deposited on the porous Ni sheet at thickness about 5 um by either screen printing or spray technique. A silicalite membrane was grown on the porous zirconia surface by methods of the present invention as described elsewhere herein. However, the resulting membrane film was readily peeled off from the Ni substrate. By contrast, the silicalite membrane directly grown on the bare Ni substrate as described and pictured in FIG. 3 adhered to the substrate very well and could not be peeled off. A complete set of data on the silicalite membrane supported on porous metallic substrate sheet/plate/disk for ethanol/water or hydrocarbon/water separation are scarce in the prior arts. Some complete sets of performance data for the H₂O-selective membrane supported on a metallic substrate are provided by Jafar et al. and by Holmes et al. Table 9 compares membrane characteristics and performance data from embodiments of the present invention with those of Jafar and Holmes. The thickness, pore size, porosity, and pore structure of those two porous metallic substrate disks were not disclosed, although they are critical parameters for a zeolite membrane product concept. The permeate pressure during separation tests of those two papers was not disclosed either. With the same type of NaA zeolite material, the membrane prepared according to the present invention shows about one order of magnitude higher water flux than those of Jafar et al., and Holmes et al. The H₂O/ethanol selectivity of the present membrane is a few orders of magnitude higher than those numbers reported by Holmes et al. Jafar et al., tested water removal from a water/iso-propanol mixture. Iso-propanol is a larger molecule than ethanol. Fundamentally, H₂O/iso-propanol selectivity should be much higher than H₂O/ethanol selectivity for the NaA-type zeolite material, because NaA pore size is small enough to exclude iso-propanol from adsorption into its pore. Table 10 shows that the present membrane provides much higher H₂O/ethanol selectivity even than H₂O/iso-propanol obtained by Jafar et al. The comparison clearly shows critical importance of the features and properties resulting from embodiments of the present invention on, membrane performance (flux, selectivity, adhesion) even for a same-type zeolite membrane material. The zeolite membrane performance is much determined by the membrane sheet structure and on preparation methods.

TABLE 9
Comparison of the NaA membrane of this invention to the same type
of zeolite membrane supported on porous metal disk in prior art.

| | | Water | | Permeate | | | |
|---|---|---|---|---|---|---|---|
| | | in feed | | pressure | Flux | H₂O | |
| Membrane | Support | (wt %) | T(K) | (kPa) | (Kg/m2/h) | Selectivity | Source |
| NaA | Thin porous | 10 wt % | 348 | 0.1-0.2 | 4.0 | >10,000 | present |
| | metal sheet | H₂O in | | | | | |
| | | ethanol | | | | | |
| NaA | same | same | 363 | 0.1-0.2 | 7.5 | >10,000 | present |
| NaA | porous | 10 wt % | 333 | NA | 1.3 to 0.7 | 1,800 to | Jafar & |
| | zirconia/Ni/Cr | H₂O in | | | | 8,000 | Budd |
| | alloy mesh, | iso- | | | | | 1997 |
| KA | Ceramesh | propanol | | | 0.4 to 1.3 | 400 | Jafar & |
| | sheet (Acumen | | | | | to 1,500 | Budd |
| | Ltd) | | | | | | 1997 |
| NaA | Stainless steel | 10 wt % | 298 | NA | 0.058 | 11.1 | Holmes |
| | sinter (Alltech | H₂O in | 313 | NA | 0.11 | 9.4 | et al. |
| | Assoc.) | ethanol | 323 | NA | 0.135 | 9.4 | 2000 |
| | | | 333 | NA | 0.205 | 12.3 | |

Jalal J. Jafar, Peter M. Budd “Separation of alcohol/water mixtures by pervaporation through zeolite A membranes” Microporous Materials 12 (1997) 305 311.
S. M. HOLMES, M. SCHMITT, C. MARKERT, R. J. PLAISTED, J. O. FORREST, P. N. SHARRATT, A. A. GARFORTHI, C. S. CUNDY and J. DWYER “ZEOLITE A MEMBRANES FOR USE IN ALCOHOL/WATER SEPARATIONS Part I: Experimental Investigation” Trans IChemE, vol. 78, Part A, pp 1084-1088, 2000.

According to some embodiments, the individual membrane sheets can be assembled into a mini-channel module. Referring to FIG. 7a, the membrane channels are formed by stacking two membrane sheets 701 front side 702 to front side 702, wherein the zeolite membrane layers are facing each other. Spacers 705 are placed between two membrane sheets to provide mechanical support to the sheet and to also define a membrane channel 704. The spacers in the membrane channel are arranged in a direction perpendicular to those that may be in the permeate flow channel 703. Permeate flow channels are formed by stacking the membrane sheets back side to back side. Preferably, the back sides make bare metal to bare metal contact, however spacers can also be used. The membrane sheets are stacked layer by layer though repeated process steps to obtain the desired number of membrane channel layers. Finally, the whole module is bonded together. Braze or sealer is applied on the two ends of the module to fill up any bypass voids from the membrane to the permeation channel. For industrial production, the whole process can be automated. Sealing glasses (e.g. alumino-barium-silicate based) and metal base brazes (e.g. Ag-based) can be used or modified for preparation of the mini-channel module.

The channel openings are a critical design parameter for the module. Selection of an optimum channel opening is a result of compromise between surface-area packing density, channel flow hydrodynamics, and potential manufacturing cost. The small channel size has a high-surface area packing density and also reduces thickness of filtration boundary layer. However, if the channel size is too small, flow hydrodynamics inside the channel and manufacturing cost become a problem. Mini-channels that have a size greater than about 0.3 mm can typically be formed with low-cost material manufacturing processes while creation of mini-channels smaller than 0.3 mm can be fairly expensive at large scales.

The mini-channel modules are preferably hosted inside a pressure enclosure. FIG. 7b shows a schematic of an exemplary membrane package 710. The feed stream 712 is divided into a water stream 711 and a concentrated stream 713 through the filtration vessel. A positive pressure gradient (1-25 bar) between the feed stream and the permeate stream is exerted during separation tests. A metallic vessel made of the same material as the membrane support is preferred. The membrane package is critical to durability and separation performance, particularly for high-pressure operation. Both flow and stress distribution is affected by the package method. The flow distribution is directly related to effective utilization of all membrane channels. The stress distribution determines mechanical integrity and durability of the testing cell.

The membrane sheets may also be packaged into a simple plate-type membrane module as illustrated in FIG. 8. Two membrane sheets 801 are sealed back side to back side, with or without a spacer, into a plate having an internal opening 803. The zeolite membrane-coated surface 802 is exposed to the feed water/hydrocarbon mixtures 804. The targeted molecule is removed from the mixture as permeate 805 though the membrane into the inner open space of the membrane plate and pulled out of the membrane module by vacuum and/or gas purge. For a given membrane sheet thickness, the width of the internal opening is the major design parameter. To pack more membrane area in unit volume, a thinner plate is preferred. To minimize the flow resistance to withdraw the permeate out of the membrane module, a thicker plate is preferred. Preferably, the width of the internal opening is between 0.3 to 6 mm.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A method for making a zeolite membrane sheet, the method characterized by the steps of:
Applying a uniform seeding layer having a thickness less than 3 μm and comprising zeolite crystals having an average diameter less than or equal to 1 μm to a bare metal surface of a front side of a porous metal support sheet, the support sheet comprising an average pore size of less than 3 μm, a porosity between 25% and 75%, and a thickness of less than or equal to 200 μm; and
Hydrothermally forming an inter-crystal growth layer by immersion of the support sheet with the seeding layer in a zeolite growth solution, the inter-crystal growth layer incorporating the seeding layer, comprising the same zeolite as the zeolite crystals, and having a thickness less than or equal to 3 μm.

2. The method of claim 1, wherein the zeolite comprises a water-selective zeolite selected from the group consisting of 3A, 4A, and 5A-type zeolite framework.

3. The method of claim 1, wherein the zeolite comprises a hydrocarbon-selective or alcohol-selective zeolite selected from the group consisting of silicalite, titanium silicate, MFI-type, and Y-type zeolite frameworks.

4. The method of claim 1, wherein said applying a uniform seeding layer further comprises performing multiple applications of the zeolite crystals in a graded pore-size structure, initially using larger zeolite crystals having average diameters between 0.5 and 3 μm and subsequently using smaller zeolite crystals having average diameters between 50 and 500 nm.

5. The method of claim 1, further comprising assembling a plurality of the zeolite membrane sheets into a mini-channel module comprising one or more permeate flow channels and one or more membrane channels, the permeate flow channel formed by stacking two membrane sheets back side to back side, and the membrane channel formed by stacking two membrane sheets with the front sides facing one another separated by spacers.

6. The method of claim 5, further comprising orienting the permeate flow channels and the membrane channels in a cross-flow configuration.

7. The method of claim 1, further comprising assembling two zeolite membrane sheets into a membrane plate module comprising a permeate flow channel, the permeate flow channel formed by stacking the zeolite membranes sheets back side to back side with the front sides exposed to feed mixtures on the exterior of the membrane plate module.

8. The method of claim 1, wherein the metallic support sheet comprises porous Ni or a porous Ni alloy.

9. The method of claim 1, wherein the metallic support sheet comprises porous Ti.

10. The method of claim 1, wherein the zeolite growth solution is a template-free solution.

11. A zeolite membrane sheet characterized by:
a seeding layer having a thickness less than 3 μm and comprising zeolite crystals having an average diameter less than or equal to 1 μm to a bare metal surface of a front side of a porous metal support sheet, the support sheet comprising an average pore size of less than 3 μm, a porosity between 25% and 75%, and a thickness of less than or equal to 200 μm; and
An inter-crystal growth layer incorporating the seeding layer, comprising the same zeolite as the zeolite crystals, and having a thickness less than or equal to 3 μm.

12. The membrane of claim 11, wherein the zeolite comprises a water-selective zeolite selected from the group consisting of 3A, 4A, 5A-type zeolite framework.

13. The membrane of claim 11, wherein the zeolite comprises a hydrocarbon-selective or alcohol-selective zeolite selected from the group consisting of silicalite, titanium silicate, MFI-type, and Y-type zeolite frameworks . . . .

14. The membrane of claim 11, wherein the seeding layer comprises zeolite crystals in a graded pore-size structure with larger zeolite crystals having average diameters between 0.5 and 5 μm near the bare metal surface and smaller zeolite crystals having average diameters between 50 and 500 nm formed on the larger zeolite crystals.

15. The membrane of claim 11, further comprising an assembly of a plurality of the membranes into a mini-channel module comprising one or more permeate flow channels and one or more membrane channels, the permeate flow channel formed by two membrane sheets stacked back side to back side, and the membrane channel formed by two membrane sheets stacked with the front sides facing one another separated by spacers.

16. The membrane of claim 15, wherein the permeate flow channels and the membrane channels are oriented in a cross-flow configuration.

17. The membrane of claim 11, further comprising an assembly of two zeolite membrane sheets into a membrane plate module comprising a permeate flow channel, the permeate flow channel formed by the zeolite membranes sheets stacked back side to back side with the front sides exposed to feed mixtures on the exterior of the membrane plate module.

18. The membrane of claim 11, wherein the metallic support sheet comprises porous Ni or a porous Ni alloy.

19. The membrane of claim 11, wherein the metallic support sheet comprises porous Ti.
